(19) United States
(12) Patent Application Publication
(10) Pub. No.: US 2004/0205502 A1
(43) Pub. Date: Oct. 14, 2004

(54) Network navigation system and method

(76) Inventor: Roger T. Baird, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/004,366

(22) Filed: Nov. 1, 2001

(51) Int. Cl. G06F 17/24

(52) U.S. Cl. 715/501.1; 715/526

(57) ABSTRACT

A navigation system includes a Web browser having a feature for displaying a list of bookmarks or favorites. The Web browser includes the ability to generate and display a list of links that are part of the Web page corresponding to an entry on the list of bookmarks or favorites. The Web browser is configured to download the source code of the Web page corresponding to an entry on the bookmarks or favorites list, and to parse the source code to extract uniform resource locators (URLs) and identifying text associated with links in the source code.

### TECHNICAL FIELD

The invention relates generally to information retrieval in a computer network. More particularly, it is related to a system and method for improved accessing of Web pages on a global computer network such as the Internet.

### BACKGROUND ART

The Internet is a well known world wide collection of networks and gateways that allow communications between computers via high-speed data communication lines between major nodes or host computers. The Internet allows users to access the World Wide Web (“the Web”). The Web is a set of interlinked hypertext documents residing on servers all around the world. Documents on the Web, known as Web pages, may be written in HTML (hypertext markup language), and are identified by URLs (uniform resource locators) that specify the particular machine and path name by which a file may be accessed and/or transferred from server to end user. Web pages may contain tags that allow users to link to other Web pages. Web pages are accessed and displayed through use of user software such as a Web browser. Examples of Web browsers are Netscape Navigator and Microsoft Internet Explorer.

One of the features of Web browsers is a list of “bookmarks” or “favorites.” Such a list may also be referred to as “hot list.” This feature allows a user to store a link to a Web page or other URL in a local file. Bookmark lists allow users to bypass the difficult task of manually entering URLs for frequently-accessed Web pages. The user may add bookmarks to his or her list by accessing a selection on a menu, for example, an “add bookmarks” selection on a bookmarks menu. This set of actions adds the URL of the current Web page as an item in the bookmarks menu. Additional information, such as the title of the Web page, may also be stored, thus enabling the bookmarks to be conveniently identified and accessed.

Even with the system of bookmarks, navigation through a Web site is often difficult and tedious. Web sites often contain large numbers of top and sub-topic Web pages within a site. For some types of Web sites, for example, news Web sites, the topic and sub-topic Web pages may have changing URLs and content, making bookmarking difficult if not impossible. In addition, the sheer number of topic and sub-topic Web pages on a single Web site may make bookmarking impractical for all but the most frequently-visited Web pages. Therefore, users commonly access a Web site through a single bookmarked Web page. Links on that Web page are then used to access various topic and sub-topic Web pages within the Web site. Such navigation from link to link may be time consuming and cumbersome.

### SUMMARY OF THE INVENTION

A system for Web navigation includes displays of links associated with entries in a bookmarks or favorites list.

According an aspect of the invention, a method for network navigation includes downloading to a computer system a page associated with a bookmark; determining non-local links within the page; and displaying, on the computer system, indicators associated with the non-local links.

According to another aspect of the invention, a computer program for network navigation, embodied in a computer readable medium, includes code that downloads a page associated with a bookmark; code that determines non-local links within the page; and code that displays indicators associated with the non-local links.

According to yet another aspect of the invention, a system for network navigation includes a processor coupled to a local interface; a memory coupled to a local interface; and processing logic stored on the memory and executable by the processor. The processing logic includes logic that downloads a page associated with a bookmark; logic that determines non-local links within the page; and logic that generates a display that includes indicators associated with the non-local links.

According to still another aspect of the invention, a system for network navigation includes means for downloading to a computer system a page associated with a bookmark; means for determining non-local links within the page; and means for displaying, on the computer system, indicators associated with the non-local links.

According to a further aspect of the invention, a method for network navigation includes downloading to a computer system a page associated with a bookmark; determining non-local links within the page; and displaying, on the computer system, indicators associated with the non-local links. The determining includes parsing source code of the page, wherein the parsing includes examining the source code for anchor tags and examining the tags to determine whether links associated with the anchor tags are local links; and extracting text from the anchor tags for the indicators. The displaying includes displaying the indicators next to an entry on a bookmark list associated with the page; and selectively displaying the indicators in response to a selecting action by a user.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention can be understood with reference to the following drawings, which are not necessarily to scale. Also, in the drawings, like reference numerals designate corresponding parts throughout the several views.

FIG. 1 is a block diagram of a network navigation system according to the an embodiment of the present invention;

FIG. 2 is a representation of a graphical user interface displayed using the network navigation system of FIG. 1;

FIG. 3 is a flowchart of some of the functionality of the network navigation system of FIG. 1; and

FIG. 4 is a flowchart of some of the functionality of the source code parsing of FIG. 3.

### DETAILED DESCRIPTION

A Web browser includes a feature of displaying links, such as non-local links (links to other Web pages), associated with entries in a bookmarks or favorites list. When the bookmarks list is activated, the Web browser displays the bookmarks list. When a selecting action (e.g., hovering or right-clicking) is performed to indicate one of the entries of the bookmarks list, the non-local links included in the corresponding Web page are displayed, for instance, in a submenu. The selecting action may be a trigger causing the Web browser to download the Web page corresponding to the indicated bookmark. The downloaded Web page may then be parsed to gather information on the non-local links that are included in the Web page corresponding to the bookmark. Text associated with the non-local links, such as an anchor tag hyperlink text, is also extracted from the Web page corresponding to the indicated bookmark. The text associated with the non-local links is then displayed, for example, in a submenu alongside the indicated bookmark. The entries in the submenu are the selectable by the user. Selection of an entry from the submenu causes the Web browser to retrieve and display the Web page corresponding to the entry in the submenu. Thus, in a single click, a user can bypass a bookmarked page and proceed directly to a non-local link on that bookmarked page. In addition, non-local links may be hierarchically displayed in a series of submenus, allowing users to proceed through many levels of links with a single click.

It will be appreciated that the above-described invention allows users to more quickly navigate through Web sites having many non-local links. For example, using the system and method described in detail below, a bookmark to a news Web site may be a basis for a display of non-local links to various categories of news topics, and to specific news stories linked to pages corresponding to the topics. It will be appreciated that users may be able to forgo the time, effort, and potential confusion, involved in finding and navigating through one or more layers of non-local links. Further, it will be appreciated that the various labels of submenus may be displayed relatively quickly. This is because downloading and parsing source code (such as HTML code) in order to obtain the non-local links may be much faster than downloading all of the items necessary to display the corresponding Web page. For example, applets or large graphics files need not be retrieved in order to perform the parsing operation, although such items must be obtained in order to fully load the corresponding Web page. In addition, it will be appreciated that the information for the non-local links may be obtained in whole or in part ahead of time, and stored on a client computer. Such information may be updated periodically, or by activation of the bookmarks menu.

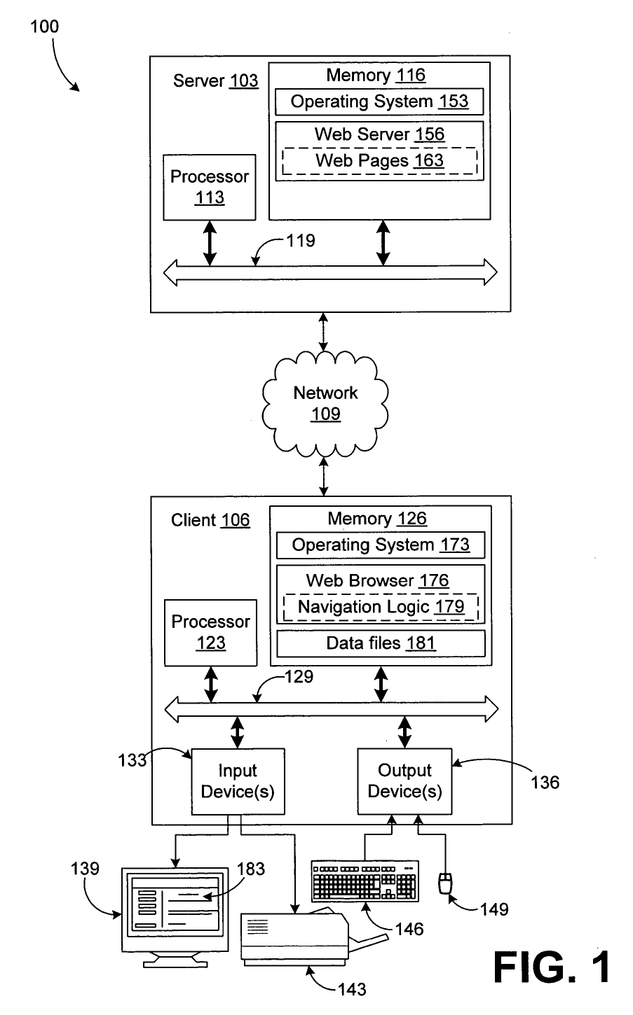

Referring initially to FIG. 1, a network navigation system 100 is shown. The network navigation system includes a server 103 and a client 106, both of which are coupled to a network 109. The server 103 may include, for example, a computer system or other apparatus with similar capability. In particular, the server 103 includes a processor circuit with a processor 113 and a memory 116, both of which are coupled to a local interface 119. The local interface 119 may include, for example, a data bus with an accompanying control/address bus, as is generally known by those with ordinary skill in the art.

Various peripheral devices may be employed with the server 103. In particular, peripheral devices to obtain user input may include, for example, a keypad, touchpad, touch screen, microphone, scanner, mouse, joystick, or one or more push buttons, etc. Peripheral devices providing user output may include display devices, indicator lights, speakers, printers, etc. Specific display devices may be, for example, cathode ray tubes (CRTs), liquid crystal display (LCD) screens, light emitting diode (LED) displays, gas plasma-based flat panel displays, etc.

The server 103 is intended to represent one of a plurality of servers coupled to the client 106 via the network 109.

The client 106 may include, for example, a computer system or other system with similar capability. In particular, the client 106 includes a processor circuit with a processor 123 and a memory 126, both of which are coupled to a local interface 129. The local interface 129 may be, for example, a data bus with an accompanying control/address bus, as is generally known by those with ordinary skill in the art. The client 106 also includes various output interfaces 133 and input interfaces 136, through which the client 106 may be connected to various peripheral devices. Such peripheral devices may include a display device 139, a printer 143, a keyboard 146, and a mouse 149. Other peripheral devices that may be employed by the client 106 to receive various user input and/or to provide user output include those listed above with regard to the server 103.

The memories 116 and 126 may include both volatile and nonvolatile memory and data storage components. Volatile components are those that do not retain data values upon loss of power. Nonvolatile components are those that retain data upon a loss of power. Thus, the memories 116 and 126 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other such of memory device.

Also, each of the processors 113 and 123 may represent multiple processors and each of the memories 113 and 123 may represent multiple memories that operate in parallel processing circuits, respectively. In such a case, each of the local interfaces 119 and 129 may be an appropriate network that facilitates communication between any two of the multiple processors, between any processor and any of the memories 116 and 126, or between any two of the memories, etc. The processors 113 and 123 may be electrical or optical in nature.

The network 109 includes, for example, the Internet, wide area networks (WANs), local area networks, or other suitable networks, etc., or any combination of two or more such networks. The server 103 and the client 106 is coupled to the network 109 to facilitate data communication to and from the network 109 in any one of a number of ways that are generally known by those of ordinary skill in the art. In this respect, the server 103 and/or the client 106 may be linked to the network 109 through various devices such as, for example, network cards, modems, or other such communications devices.

The server 103 also includes various software components that are stored on the memory 116 and are executable by the processor 113. These components include an operating system 153 and a Web server 156 are stored on the memory 116. The Web server 156 includes one or more Web pages 163.

The client 106 also includes a number of software components that are stored on the memory 126 and are executable by the processor 123. These components include an operating system 173 and a Web browser 176. By manipulating the browser 176, the pages 163 may be downloaded from the server 103 having been transmitted by the Web server 156, stored on the memory 116 of the server 103. Thus, the browser 176 and the Web server 156 may operate according to the dictates of the World Wide Web protocol, for example, or another suitable protocol. In this sense, the Web pages 163 may be created using hypertext markup language (HTML), as is generally known by those with ordinary skill in the art. Alternatively, other programming languages may be employed to create the Web pages 163, including Extensible Markup Language (XML) or another markup language, JAVA, Active Server Page Scripting (ASP), Javascript, C++, or other suitable computer languages. It will also be appreciated that the pages 163 may include other types of pages and/or data files. The memory 126 also includes navigation logic 179 and data files 181.

The navigation logic 179, which may be part of the Web browser 176, aids in navigation through various Web pages accessible through the network 109. In particular, the navigation logic 179 may facilitate navigation through various of the Web pages 163 maintained on the server 103. However, the navigation logic 179 may more broadly aid navigation through various Web pages on other Web servers linked to by the Web pages 163 on the Web server 156. The data files 181 may include data regarding links found in the Web pages 163, as explained in greater detail below.

Both of the operating systems 153 and 173 are executed to control the allocation and usage of hardware resources in the server 103 and the client 106, respectively. Specifically, the operating systems 153 and 173 control the allocation and usage of the memory 116/126, processing time, and the peripheral devices as well as performing other functionality. In this manner, the operating systems 153 and 173 serve as the foundation on which applications depend as is generally known by those with ordinary skill in the art.

In addition, the processor 123 of the client 106 may execute the Web browser 176 to interpret one or more of the Web pages 163 downloaded form the server 103. Based on the Web pages 163, the browser 176 generates corresponding graphical user interfaces (GUIs) 183 on the display device 139, that may be manipulated by the user of the client 106.

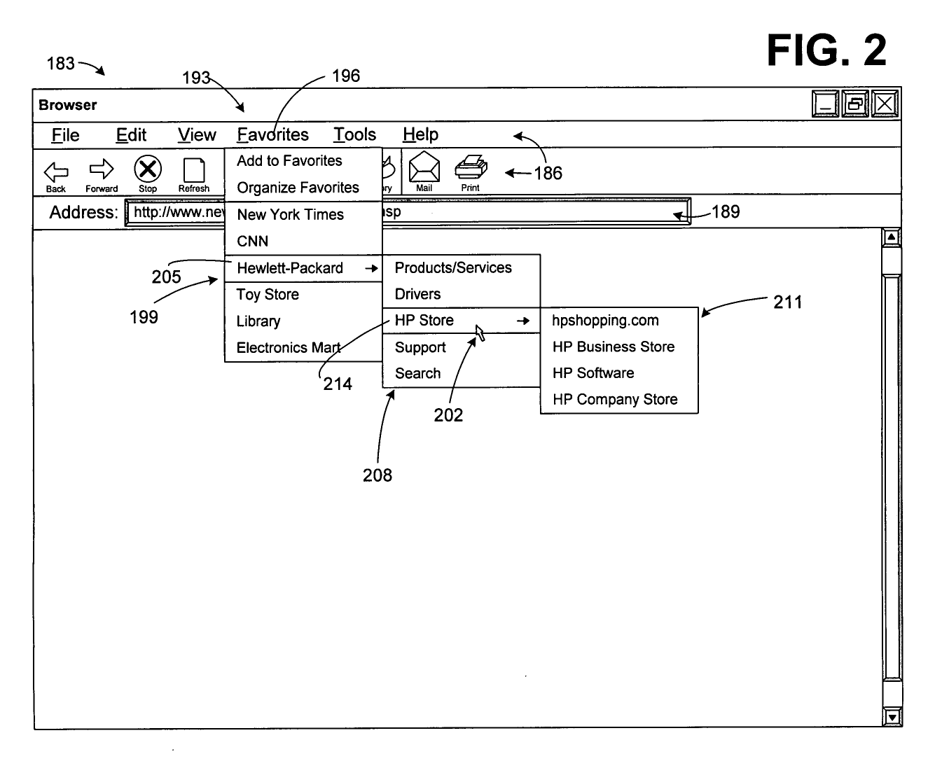

With reference now to FIG. 2, an illustration is shown of the graphical user interface (GUI) 183 according to an aspect of the present invention. The graphical user interface 183 shows various browser components 186, as well as an address box 189 that may be manipulated to access various of the Web pages 163 (FIG. 1) on various servers 103 (FIG. 1) coupled to the network 109 (FIG. 1). Specifically, a user may enter a uniform resource locator (URL) in the address box 189 to address a specific Web page 163 located at a specific server 103.

The browser component 186 includes a bookmark feature 193. The bookmark feature 193 includes a bookmark activator 196 for actuating a bookmark menu 199. The activator 196 may be actuated by clicking on a specified area of the GUI 183, for example, by moving a cursor 202 to the specified area and performing a specified task, such as clicking a button. The cursor 202 may be moved by a mouse, trackball, or other pointing device, or may be moved by use of one or more keyboard commands. Actuation to display the pull-down menu 199 may be accomplished by clicking a button on the mouse or trackball, or by pressing a specified key on the keyboard. It will be appreciated that other methods of activating a pull-down menu are possible. For example, a touch screen may be employed. Alternatively, a series of keyboard commands, for example utilizing control and/or escape keys, may be used. As another alternative, devices such as light pens may be employed to activate the bookmarks menu 199. It will be appreciated that the GUI 183 may alternatively use a different hierarchical structure, such as drop down menus, trees, etc.

The navigation logic 179 includes logic to display, on the GUI 183, indicators associated with links on the Web pages corresponding to the entries on the bookmark menu 199. For example, when a selecting action is performed on a bookmark 205 of the bookmark menu 199, a submenu 208 is displayed. The submenu 208 displays text associated with the non-local links of the Web page 163 corresponding to the bookmark 205 (“the corresponding Web page”). “Non-local links,” as used herein broadly indicates links that are outside the corresponding Web page. Such non-local links may be links to other Web pages, or may be links to activate other functions, for example, file transfer protocol (FTP), e-mail, Telnet, etc.

The display of the submenu 208 may be actuated by a selecting action. The selecting action for displaying the submenu 208 corresponding to the bookmark 205 may be any of a variety of suitable actions. For example, the selecting action may involve simply moving the cursor 202 atop the text of the bookmark 205, or in an area corresponding to the bookmark 205. Alternatively, the selecting action may involve “hovering” (maintaining the cursor 202 in an area corresponding to the bookmark 205 for a specified period of time). As another alternative, the selecting action may involve clicking a button, such as a button on a mouse or trackball, while in the area of the GUI 183 corresponding to the bookmark 205. Such clicking may involve a single click, such as clicking a right-hand mouse button, or may involve multiple clicks, such as double-clicking a mouse button, or clicking two mouse buttons at the same time. As another alternative, selecting action may include pressing one or more keys on a keyboard. It will be appreciated that other suitable selecting actions will be apparent to one skilled in the art.

The selecting action for actuating the display of the submenu 208 is different from a second selecting action to cause the Web browser 176 to access and display the corresponding Web page 163 on the graphical user interface 183.

The action of selecting the bookmark 205 for the displaying of the corresponding submenu 208 may signal the client 106 to download the corresponding Web page, and determine the non-local links in that Web page. Thus, the selecting action may cause the client 106 to access the appropriate server 103 and download the corresponding Web page 163. The corresponding Web page 163 may then be parsed by the navigation logic 179 to determine the non-local links on that Web page. For example, the navigation logic 179 may search line by line through the source code of the corresponding Web page 163, searching for anchor tags. When an anchor tag is found, the navigation logic 179 may make a determination as to whether the tag corresponds to a local link or a non-local link. If the anchor tag corresponds to a non-local link, the Uniform Resource Locator (URL) of the tag may be extracted from the source code. Also, identifying text associated with the link may be extracted. The identifying text may be, for example, hyperlink text from the anchor tags. Thus the identifying text may be the text that would be displayed on the corresponding Web page 163 as a selectable hyperlink. This process of determining the links and the locators and text associated therewith, generally is referred to herein as “parsing.”

Many variants are possible on the parsing process described above. For example, the determining of the text associated with a non-local link may include downloading the corresponding Web page 163 and extracting the title of the Web page for use as the associated identifying text. This downloading and extracting may be used as an alternative for situations in which there is no anchor tag text associated with a non-local link, for example when a non-local link corresponds to a graphic image.

It will be appreciated that the process of downloading the corresponding Web page 163 and parsing the corresponding Web page 163 to determine the non-local links may be performed prior to the selecting action of selecting the bookmark 205. For example, upon startup of the Web browser 176, the navigation logic 179 may be configured to download and parse all of the Web pages 163 corresponding to the bookmarks in the bookmarks menu 199. The information on the non-local links (the URLs or other locators and the associated identifying text) may be stored in the memory 126 of the client 106. In addition the navigation logic 179 may be configured to periodically re-download the Web pages corresponding to the bookmarks 199, to update the list of non-local links. Updating the list of non-local links may be particularly desirable for Web sites that change links on a relatively frequent basis. For example, updating non-local links may be desirable for a news Web site for which links to news stories are displayed only for a relative short period of time, such as hours or days.

It will further be appreciated that the selecting action of selecting the bookmark 205 may itself be used to actuate updating of the non-local links corresponding to the bookmark 205. For instance, selecting the bookmark 205 may cause the submenu 208 of the corresponding non-local links to be displayed, while at the same time causing the corresponding Web page 163 to be downloaded and parsed. After the corresponding Web page has been downloaded and parsed, update information may be provided to, if necessary, update the information on the submenu 208. The updating may involve adding entries, modifying entries, and/or deleting entries. It will be appreciated that retrieving information on non-local links prior to the selecting action may improve performance time, allowing the submenu 208 of the non-local links to be displayed more rapidly than when the selecting action of the bookmark 205 initiates the information retrieval and processing necessary to generate the submenu 208.

It will be appreciated that the process of downloading and displaying the corresponding Web page 163 may be significantly faster, and require significantly less computing power, than the process of downloading and displaying the Web page 163. This is because the source code for the corresponding Web page 163 may include instructions to the Web browser 176 to download graphical files, applets, or other large files. In order to load and display the Web page 163, it will be appreciated that such other files may need to be downloaded. In contrast, such other files need not be downloaded in order to simply parse the source code of the corresponding Web page 163, in order to uncover and extract information regarding the non-local links.

The Web pages corresponding to the non-local links may be selectable directly from the submenu 208. For example, a non-local link may be selected by movement of the cursor 202 onto an area corresponding to an entry in the submenu 208, and performing a specified task, for example, left-clicking using a mouse button. Alternatively, it will be appreciated that the information regarding the non-local links may be provided for informational purposes only, in order to allow a user to scan the non-local links on a Web page without having direct access to the non-local links.

The navigation logic 179 may be configured to allow generation and display of second-order submenus, including information corresponding to the non-local links on the Web pages 163 corresponding to the entries on the submenu 208. The second-order submenu 211 includes indications of links found on the Web page corresponding to the link 214. This is illustrated in FIG. 2, where a second-order submenu 211 corresponds to a non-local link 214 in the submenu 208. The generation of the second-order submenu 211 may utilize a process similar to the processes described above for generation of the submenu 208. It will be appreciated that multiple orders of submenus may be generated, thus allowing a user of the client 106 to easily navigate through a chain of non-local links ultimately leading back to a Web page corresponding to the bookmark 205. It will be appreciated that the navigation logic 179 may be configured such that information corresponding to some orders of non-local links, for example, first- and second-order non-local links, may be stored in memory, while information for higher order non-local links may be accessed only when necessary for display.

As another alternative, the identifying text displayed in the submenu 208 may be all or part of the URL of the corresponding Web page. It will be appreciated that there may be a hierarchical system for determining the identifying text to be displayed in submenu 208. For example, the navigation logic 179 may be configured to display the hyperlink text in the anchor tag, if any. If there is no hyperlink text in the anchor tag, the navigation logic 179 may be configured such that the Web page corresponding to the non-local link is downloaded, and the title of that Web page is extracted and used as the identifying text for the corresponding non-local link. If neither of these steps results in obtaining identifying text, then the navigation logic 179 may utilize the URL of the non-local link as the identifying text. It will be appreciated that only a portion of the URL may be utilized, and/or that the navigation logic 179 may be configured to truncate the identifying text if the URL exceeds a certain number of characters. It will be appreciated that other suitable methods of generating identifying text may be used.

The displays of non-local links have been shown in FIG. 2 and described above in terms of lists in the submenu 208 and the second-order submenu 211, adjacent to the corresponding bookmark 205 and the non-local link 214, respectively. However, it will be appreciated that the non-local links may be displayed by other methods in another context. For example, the non-local links may be displayed in pop-up windows on other parts of the GUI 183. Alternatively, the links may appear as part of the bookmark menu 199. For example, the links shown as part of the submenu 208 may alternatively be displayed in the bookmark menu 199 immediately below the corresponding bookmark 205. The non-local links displayed as part of the bookmark menu 199 may be indented, for example, to indicate that they are non-local links.

It will be appreciated that some or all of the various features described above may be selectable by a user, for example, being selectable from a range of alternatives. For instance, the particular selecting action that causes the non-local links to be displayed may be selectable by the user of the client 106, from a range of possible alternatives.

Although the navigation logic 179 has sometimes been described above in terms of extracting only non-local links from the Web page corresponding to the bookmark 205, it will be appreciated that local links (links to positions within the associated Web page) may also be extracted and displayed in the submenu 208. Display of local links may aid users in directly accessing a desired position within a favorite Web page.

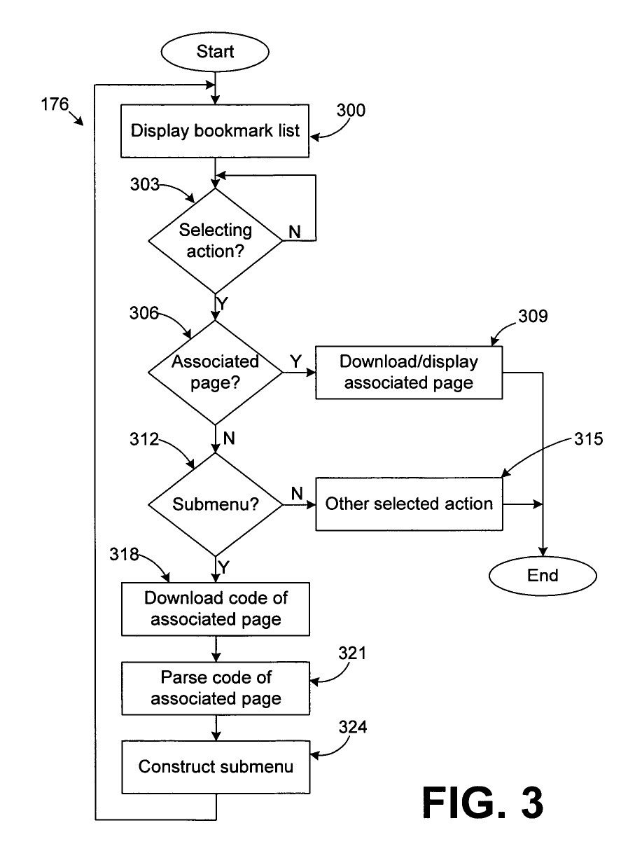

FIG. 3 shows a flowchart of the general functionality (logical function) of the Web browser 176, including the navigation logic 179 (FIG. 1) of the client 106 (FIG. 1). Alternatively, the flowchart of FIG. 3 may represent method steps taken in executing the Web browser 176, including the navigation logic 179. In block 300 a bookmark list, such as the bookmark menu 199 (FIG. 2), is displayed on the GUI 183 (FIG. 1). In block 303 the Web browser 176 awaits a selection action by the user of the client 106. When a selecting action is received by the Web browser 176, in block 306 the selection action is examined to determine if it is a selection to download and display a Web page 163 (FIG. 1) corresponding to a bookmark on the bookmarks list 199. If so, in block 309 the associated Web page 163 is downloaded and displayed on the GUI 183. As part of the download and display process in block 309, the Web browser 176 stops displaying the bookmark menu 199. A common selecting action for downloading and displaying a Web page associated with a bookmark is by using a mouse to position a cursor on the text in the bookmark menu 199, and clicking a left mouse button. This method of selecting a Web page for display from a bookmarks menu is utilized in both Netscape Navigator and Microsoft Internet Explorer.

If the selecting action is not an action to select an associated page from the bookmarks menu 199, then in block 312 the selecting action is examined to determine whether it is a request to display a submenu of non-local links. An example of such a submenu is the submenu 208 shown in FIG. 2. If the selecting action is not for displaying a submenu, then in block 315 another action corresponding to the selecting action is performed. It will be appreciated that there are a wide variety of other actions that may be selected in the GUI 183. For example, moving the cursor 202 (FIG. 2) to an area not covered by the bookmark menu 199 or a corresponding submenu may result in the Web browser 176 ceasing display of the bookmarks menu 199. Alternatively, moving the cursor 202 to another one of the browser components 186 and performing a selecting action such as clicking a left mouse button may cause a different corresponding action. It will be appreciated that that user actions such as keyboard commands may also cause other actions to be taken by the Web browser 176.

If the selecting action instructs the Web browser 176 to display the non-local links associated with the Web page in the bookmark list 199, in block 318 the source code of the associated Web page is downloaded. Then in block 321 the source code is parsed to extract the non-local links and text associated with those links. Finally, in block 324 a submenu such as the submenu 208 is constructed. The Web browser 176 then returns to block 300 to display the updated bookmark list, including the submenu.

It will be appreciated that the blocks shown in FIG. 3 are only one example of the possible range of actions taken in displaying a submenu or other list of links found in a Web page corresponding to a bookmarker favorite. It will be appreciated that the full range of other suitable methods/functions described above with regard to FIG. 2 may be realized with suitable modifications of the flowchart shown in FIG. 3.

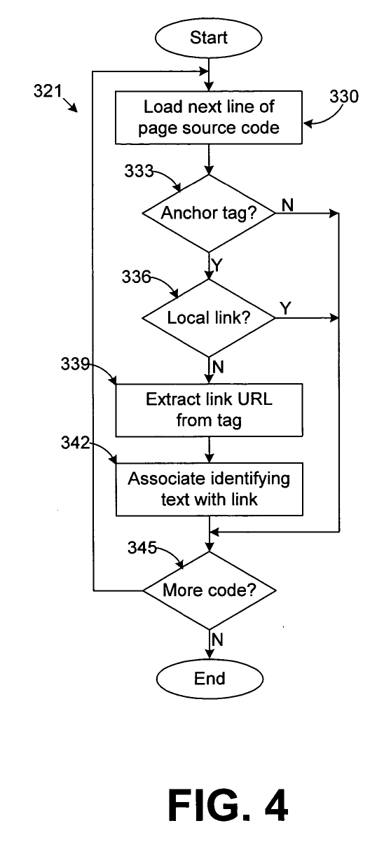

Turning now to FIG. 4, details are shown of block 321, in which the source code is parsed. In block 330 the next line (or first line) of the downloaded Web page source code is loaded into a memory or otherwise made ready for examination. In block 333 the line of source code is examined to determine if it contains an anchor tag. If it does contain an anchor tag, then in block 336 the link is examined to determine it is a local link or a non-local link. If the link is a non-local link, in block 339 the URL of the link is extracted from the tag, and in block 342 identifying text is associated with the link. The URL and the associated identifying text may be stored in memory, and may be stored in a data file 181 for future reference. As discussed above, the identifying text associated with the link may be extracted from the anchor tag, may be the title of the Web page corresponding the URL, and/or may be all or part of the URL itself.

In block 345, a determination is made as to whether there is more source code that needs to be parsed. If so, the parsing block 321 returns to block 330, to load the next line of source code. If not, the parsing block 321 ends.

Although the Web browser logic 176 and navigation logic 179 (FIG. 1) of the present invention is embodied in software or code executed by general purpose hardware as discussed above, as an alternative the Web browser logic 176 and navigation logic 179 may also be embodied in dedicated hardware or a combination of software/general purpose hardware and dedicated hardware. If embodied in dedicated hardware, the Web browser logic 176 and the navigation logic 179 (FIG. 1) can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The block diagrams and/or flowcharts of FIGS. 3 and 4 show the architecture, functionality, and operation of an implementation of the Web browser/navigation logic 176/179 (FIGS. 3 and 4). If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the block diagrams and/or flowcharts of FIGS. 3 and 4 show a specific order of execution, it is understood that the order of execution may differ from that which is depicted. For example, the order of execution of two or more blocks may be scrambled relative to the order shown. Also, two or more blocks shown in succession in FIGS. 3 and 4 may be executed concurrently or with partial concurrence. In addition, any number of counters, state variables, warning semaphores, or messages might be added to the logical flow described herein, for purposes of enhanced usability, accounting, performance measurement, or providing troubleshooting aids, etc. It is understood that all such variations are within the scope of the present invention. Also, the block diagram and/or flowcharts of FIGS. 3 and 4 are relatively self-explanatory and are understood by those with ordinary skill in the art to the extent that software and/or hardware can be created by one with ordinary skill in the art to carry out the various logical functions as described herein.

Also, where the navigation logic 179 (FIG. 1) comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the navigation logic 179 (FIG. 1) for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method for network navigation, the method comprising:
downloading to a computer system a page associated with a bookmark;
determining non-local links within the page; and
displaying, on the computer system, indicators associated with the non-local links.

2. The method of claim 1, wherein the displaying includes displaying the indicators next to an entry on a bookmark list associated with the page.

3. The method of claim 2, wherein the displaying includes selectively displaying the indicators in response to a selecting action by a user.

4. The method of claim 3, wherein the downloading and the determining are actuated by the selecting action.

5. The method of claim 3, wherein the indicators are stored on the computer system, and the displaying includes displaying the indicators.

6. The method of claim 5, wherein the selecting action actuates updating of the indicators by the downloading and the determining.

7. The method of claim 3, wherein the selecting action includes hovering over the entry.

8. The method of claim 1, wherein the determining includes parsing source code of the page.

9. The method of claim 8, wherein the parsing includes examining the source code for anchor tags.

10. The method of claim 9, wherein the parsing includes examining the tags to determine whether links associated with the anchor tags are local links.

11. The method of claim 9, wherein the determining includes extracting text from the anchor tags for the indicators.

12. The method of claim 1, wherein the indicators are stored on the computer system, and the displaying includes displaying the indicators.

13. The method of claim 12, wherein the indicators are updated by periodically performing the downloading and the determining.

14. A computer program, for network navigation, embodied in a computer readable medium, comprising:
code that downloads a page associated with a bookmark;
code that determines non-local links within the page; and
code that displays indicators associated with the non-local links.

15. The computer program of claim 14, wherein the code that displays Includes code that displays the indicators next to an entry on a bookmark list associated with the page.

16. The computer program of claim 15, wherein the code that displays includes code that selectively displays the Indicators in response to a selecting action by a user.

17. The computer program of claim 16, wherein the code that downloads and the code that determines are actuated by the selecting action.

18. The computer program of claim 16, wherein the code that displays includes code that displays stored indicators stored on a computer system.

19. The computer program of claim 18, further comprising code that updates the stored indicators by the downloading and the determining in response to the selecting action.

20. The computer program of claim 14, wherein the code that determines includes code that parses source code of the page.

21. The computer program of claim 20, wherein the code that parses includes code that examines the source code for anchor tags.

22. The computer program of claim 21, wherein the code that parses includes code that examines the tags to determine whether links associated with the anchor tags are local links.

23. The computer program of claim 22, wherein the code that determines includes code that extracts text from the anchor tags for the indicators.

24. A system for network navigation, comprising:
a processor coupled to a local interface;
a memory coupled to a local interface; and
processing logic stored on the memory and executable by the processor including:
logic that downloads a page associated with a bookmark;
logic that determines non-local links within the page; and
logic that generates a display that includes indicators associated with the non-local links.

25. A system for network navigation, comprising:
means for downloading to a computer system a page associated with a bookmark;
means for determining non-local links within the page; and
means for displaying, on the computer system, indicators associated with the non-local links.

26. A method for network navigation, the method comprising:
downloading to a computer system a page associated with a bookmark;
determining non-local links within the page, wherein the determining includes:
parsing source code of the page, wherein the parsing includes:
examining the source code for anchor tags; and
examining the tags to determine whether links associated with the anchor tags are local links; and
extracting text from the anchor tags for indicators associated with the non-local links; and
displaying the indicators on the computer system, wherein the displaying includes:
displaying the Indicators next to an entry on a bookmark list associated with the page; and
selectively displaying the indicators in response to a selecting action by a user.
